(19) United States
(12) Patent Application Publication
(10) Pub. No.: US 2019/0012698 A1
(43) Pub. Date: Jan. 10, 2019

(54) Method and System for Creating Virtual Focus Group Campaigns

(71) Applicant: Brad Austin, KIRKLAND, WA (US)

(72) Inventor: Brad Austin, KIRKLAND, WA (US)

(21) Appl. No.: 16/029,510

(22) Filed: Jul. 6, 2018

Related U.S. Application Data
(60) Provisional application No. 62/528,994, filed on Jul. 6, 2017.

(51) Int. Cl. G06Q 30/02

(52) U.S. Cl. CPC G06Q 30/0245; G06Q 30/0214; G06F 3/0482; G06Q 30/0211; G06Q 30/0276

(57) ABSTRACT

Customers are able to create campaigns that consist of either polls, ads, or coupons and will receive direct feedback from the consumer(s) they inquire with. Campaigns are delivered by a software platform where the campaign is delivered to participating consumers without the consumers having to physically travel somewhere. Consumers will receive push notifications on their smartphones through a mobile app letting them know that they have an inquiry. The consumers will then read the poll/ad/coupon, provide their feedback, and get paid. Feedback is provided in a couple different ways, depending on the type of campaign. In polls and ads, feedback comes in the form of a choice of either yes or no answers or an answer from a multiple choice question. With coupons, members provide their feedback by choosing to either save the coupon to their coupon wallet in the mobile app, or discard it if they are not interested.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to electronic surveys. More specifically, the present invention relates to a system and method for recruiting mobile app users to participate in surveys.

### BACKGROUND OF THE INVENTION

Traditional focus groups are extremely expensive and time consuming, making them inaccessible to the average small to mid-sized business, which means that the only companies that can afford to conduct focus groups are the ones with the million/billion dollar marketing budgets. These large companies are happy to spend the money though because they know how effective the consumer insight from these focus groups really is.

Therefore, what is needed is a system and method that levels the playing field between large and small to mid-sized businesses that will provide any company with the ability to create virtual focus group campaigns at a price point affordable for small to mid-sized businesses.

### Definitions

Unless stated to the contrary, for the purposes of the present disclosure, the following terms shall have the following definitions:

“Application software” is a set of one or more programs designed to carry out operations for a specific application. Application software cannot run on itself but is dependent on system software to execute. Examples of application software include MS Word, MS Excel, a console game, a library management system, a spreadsheet system etc. The term is used to distinguish such software from another type of computer program referred to as system software, which manages and integrates a computer's capabilities but does not directly perform tasks that benefit the user. The system software serves the application, which in turn serves the user.

The term “app” is a shortening of the term “application software”. It has become very popular and in 2010 was listed as “Word of the Year” by the American Dialect Society

“Apps” are usually available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

“API” In computer programming, an application programming interface (API) is a set of routines, protocols, and tools for building software applications. An API expresses a software component in terms of its operations, inputs, outputs, and underlying types. An API defines functionalities that are independent of their respective implementations, which allows definitions and implementations to vary without compromising each other.

“Email” or “electronic messages” is defined as a means or system for transmitting messages electronically as between computers or mobile electronic devices on a network.

“Electronic Mobile Device” is defined as any computer, phone, smartphone, tablet, or computing device that is comprised of a battery, display, circuit board, and processor that is capable of processing or executing software. Examples of electronic mobile devices are smartphones, laptop computers, and table PCs.

“GUI”. In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard.

The Hypertext Transfer Protocol (HTTP) is an application protocol for distributed, collaborative, hypermedia information systems. [1] HTTP is the foundation of data communication for the World Wide Web. Hypertext is structured text that uses logical links (hyperlinks) between nodes containing text. HTTP is the protocol to exchange or transfer hypertext.

The Internet Protocol (IP) is the principal communications protocol in the Internet protocol suite for relaying datagrams across network boundaries. Its routing function enables internetworking, and essentially establishes the Internet.

An Internet Protocol address (IP address) is a numerical label assigned to each device (e.g., computer, printer) participating in a computer network that uses the Internet Protocol for communication. An IP address serves two principal functions: host or network interface identification and location addressing.

An Internet service provider (ISP) is an organization that provides services for accessing, using, or participating in the Internet.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “mobile device” is a generic term used to refer to a variety of devices that allow people to access data and information from where ever they are. This includes cell phones and other portable devices such as, but not limited to, PDAs, Pads, smartphones, and laptop computers.

A “module” in software is a part of a program. Programs are composed of one or more independently developed modules that are not combined until the program is linked. A single module can contain one or several routines or steps.

A “module” in hardware, is a self-contained component.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used. A software module is defined as a series of process steps stored in an electronic memory of an electronic device and executed by the processor of an electronic device such as a computer, pad, smart phone, or other equivalent device known in the prior art.

A “software application module” is a program or group of programs designed for end users that contains one or more files that contains instructions to be executed by a computer or other equivalent device.

A “smartphone” (or smart phone) is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smartphones include all of those plus the features of a touchscreen computer, including web browsing, wideband network radio (e.g. LTE), Wi-Fi, 3rd-party apps, motion sensor and mobile payment.

URL is an abbreviation of Uniform Resource Locator (URL), it is the global address of documents and other resources on the World Wide Web (also referred to as the “Internet”).

A “User” is any person registered to use the computer system executing the method of the present invention.

In computing, a “user agent” or “useragent” is software (a software agent) that is acting on behalf of a user. For example, an email reader is a mail user agent, and in the Session Initiation Protocol (SIP), the term user agent refers to both end points of a communications session. In many cases, a user agent acts as a client in a network protocol used in communications within a client-server distributed computing system. In particular, the Hypertext Transfer Protocol (HTTP) identifies the client software originating the request, using a “User-Agent” header, even when the client is not operated by a user. The SIP protocol (based on HTTP) followed this usage.

A “web application” or “web app” is any application software that runs in a web browser and is created in a browser-supported programming language (such as the combination of JavaScript, HTML and CSS) and relies on a web browser to render the application.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site.

### SUMMARY OF THE INVENTION

The present invention is a full spectrum marketing solution providing businesses of all types and sizes with a real-time, direct consumer-to-business feedback loop by way of virtual focus groups. The present invention is inherently comprehensive because it allows a company to conduct all of its market research before deploying its marketing campaigns, which are also done from within the platform.

The method and system of the present invention teaches where customers are able to create campaigns that consist of either polls, ads, or coupons and will receive direct feedback from the consumer(s) they inquire with. The reason customers are guaranteed to receive that feedback is because, just like traditional focus groups, these consumer will get paid real money for providing their feedback. The present invention teaches a platform where the campaign is delivered to participating consumers without the consumers having to physically travel somewhere to physically sit with a bunch of strangers to discuss a product or receive a product for use and review in a limited time period and setting.

With the present invention the consumers will receive push notifications on their smartphones through a mobile app letting them know that they have an inquiry. The consumers will then read the poll/ad/coupon, provide their feedback, and get paid, all on the go. The present invention is a win-win all around—advertisers get the insight and feedback they need to better serve consumers and future customers, and consumers get paid for providing their invaluable feedback to advertisers.

### BRIEF DESCRIPTION OF THE DRAWINGS

The accompanying drawings, which are incorporated herein form a part of the specification, illustrate the present invention and, together with the description, further serve to explain the principles of the invention and to enable a person skilled in the pertinent art to make and use the invention.

FIG. 1 is a flow chart illustrating the member process of the present invention.

FIG. 2 is a flow chart illustrating the business/advertiser process of the present invention.

FIG. 3 is a spreadsheet illustrating the member compensation plan of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The method and system of the present invention teaches where customers are able to create campaigns that consist of either polls, ads, or coupons and will receive direct feedback from the consumer(s) they inquire with. The reason customers are guaranteed to receive that feedback is because, just like traditional focus groups, these consumer will get paid real money for providing their feedback.

The present invention teaches a platform where the campaign is delivered to participating consumers without the consumers having to physically travel somewhere to physically sit with a bunch of strangers to discuss a product or receive a product for use and review in a limited time period and setting. The present invention is inherently comprehensive because it allows a company to conduct all of its market research before deploying its marketing campaigns, which are also done from within the platform.

With the present invention, the consumers will receive push notifications on their smartphones through a mobile app letting them know that they have an inquiry. The consumers will then read the poll/ad/coupon, provide their feedback, and get paid, all on the go.

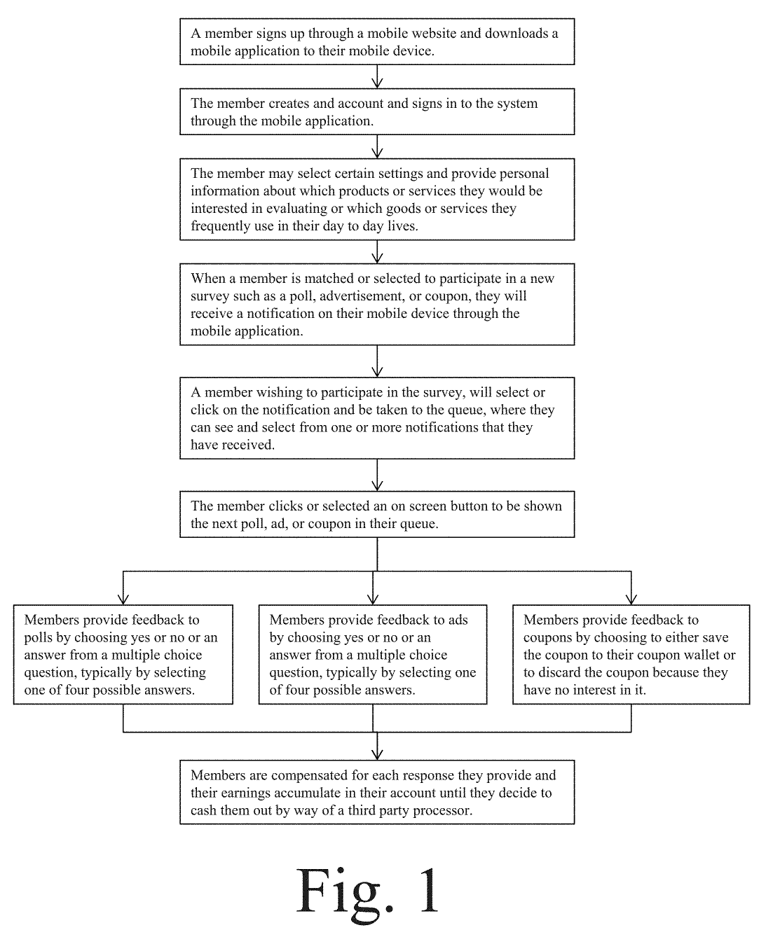

Now referring to FIG. 1, the member process is illustrated. In a first step, the member signed up through a mobile website and downloads a mobile application to their mobile device. Next the member creates and account and signs in to the system through the mobile application. The member may select certain settings and provide personal information about which products or services they would be interested in evaluating or which goods or services they frequently use in their day to day lives. This will assist the application and system in targeting the best members in the database and matching and selecting them for new surveys as they become available.

Advertisers will have limited demographic information to use to identify the members they would like to send their polls/ads/coupons to. When members sign up, they provide the following required identifying information: First name, last name, male/female, email, and zip code. Advertisers will start out with this info already available to them when they create their campaigns and will be the info they use to search the database for the members they want to send their campaigns to. Advertisers will not have access to members' personal identifying information. They will search the database with that information, but they will never have access to any member's mobile number and will never be able to match mobile numbers with personal preferences to identify anyone.

Regarding member selection ability for advertisers, in one scenario, a small business owner who really has no clue who his target market is uses the method of the present invention. If this is the case, it doesn't matter if they know exactly which age range to target because the feedback they would receive would let them know whether or not that group were potential customers or if they were even interested in what the business offers.

In another embodiment, the present invention can provide a truly educational assistance experience to those advertisers who aren't savvy marketers by combining the system with marketing experts/consultants that advertisers have access to.

In the first embodiment of the present invention, advertisers will have to create new pools of customers for themselves using the system. Even if it takes them ten campaigns asking various questions to create a pool of people they know are interested in their product, it will still be significantly less expensive than if they had to try to acquire that info through traditional means. It would also take them significantly less time to acquire that info with the present invention.

In another embodiment, affiliates will be trained and will be able to assist their advertiser customers with setting up campaigns, creating content for their campaigns, etc., and although they may not be certified marketing specialists, they will have enough general knowledge to point advertisers in the right direction so that a situation where the advertiser receives no positive feedback or results from using the present invention will not occur.

When a member is matched or selected to participate in a new survey such as a poll, advertisement, or coupon, they will receive a notification on their mobile device through the mobile application. A member wishing to participate in the survey, will select or click on the notification and be taken to the queue, where they can see and select from one or more notifications that they have received.

Next, the member clicks or selected an on screen button to be shown the next poll, ad, or coupon in their queue. Members provide feedback to polls by choosing yes or no or an answer from a multiple choice question, typically by selecting one of four possible answers. Members provide feedback to ads by choosing yes or no or an answer from a multiple choice question, typically by selecting one of four possible answers. With respect to ads, an image may also be shown as well as part of the question presented. Members provide feedback to coupons by choosing to either save the coupon to their coupon wallet or to discard the coupon because they have no interest in it. Members are compensated for each response they provide and their earnings accumulate in their account until they decide to cash them out by way of a third party processor such as PAYPAL.

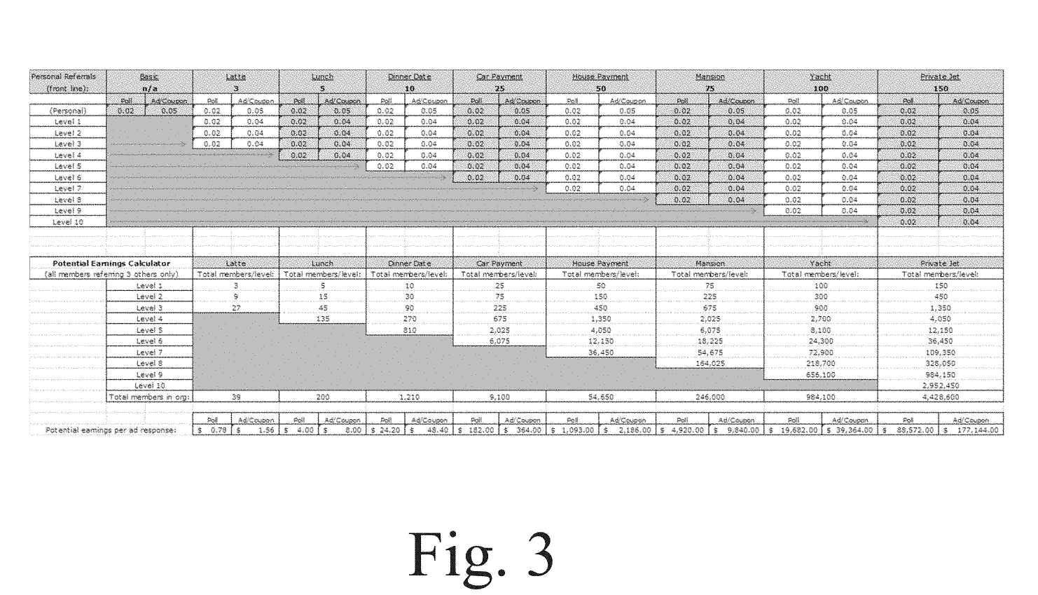

Members are highly incentivized to share the present invention with other people, as they can earn significantly more money simply by referring others to sign up as shown by the member compensation plan of FIG. 3. Members gain access to more levels of compensation by referring more people that result in actual sign ups. Members get paid extra anytime any of their personal referrals provides feedback, and also get paid extra whenever anyone that's within their referral network provides feedback.

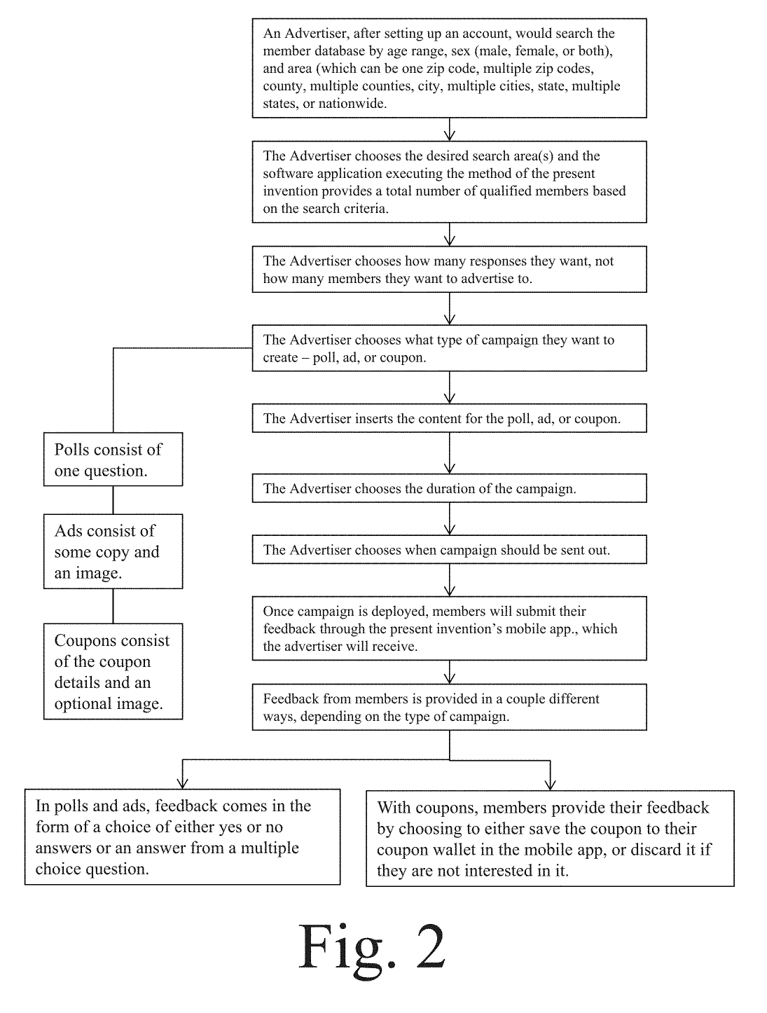

Now referring to FIG. 2, the method and steps for Advertisers to create virtual focus group campaigns using the present invention are illustrated.

First, an Advertiser, after setting up an account, would search the member database by age range, sex (male, female, or both), and area (which can be one zip code, multiple zip codes, county, multiple counties, city, multiple cities, state, multiple states, or nationwide. The Advertiser chooses the desired search area(s) and the software application executing the method of the present invention provides a total number of qualified members based on the search criteria.

Next, an Advertiser chooses how many responses they want, not how many members they want to advertise to. This is unique because it gives the advertiser full control of their costs, unlike traditional advertising. The software executing the method of the present invention will send the poll/ad/coupon to all qualified members in the designated search area, which creates a sense of urgency for members to respond because the members that will get paid for their feedback in this campaign is limited to the number of responses the advertiser chooses. The rest will miss out on the opportunity to get paid if they do not respond soon enough.

The Advertiser chooses what type of campaign they want to create—poll, ad, or coupon. Polls consist of one question. Ads consist of some copy and an image. Coupons consist of the coupon details and an optional image. The Advertiser inserts the content for the poll, ad, or coupon. The Advertiser chooses the duration of the campaign, which can be up to a maximum of seven days. The Advertiser chooses when campaign should be sent out, which can be immediately or at a future time, whether that is 15 minutes from then or in 3 days at 4 pm. The Advertiser starts campaign.

Once campaign is deployed, members will submit their feedback through the present invention's mobile app., which the advertiser will receive. The present invention provides a full spectrum marketing solution because it allows a business to conduct in depth market research up front and then create campaigns to market to those that are shown to be their target market.

Feedback from members is provided in a couple different ways, depending on the type of campaign. In polls and ads, feedback comes in the form of a choice of either yes or no answers or an answer from a multiple choice question. With coupons, members provide their feedback by choosing to either save the coupon to their coupon wallet in the mobile app, or discard it if they are not interested in it.

The system is set to run on a computing device or mobile electronic device. A computing device or mobile electronic device on which the present invention can run would be comprised of a CPU, Hard Disk Drive, Keyboard, Monitor, CPU Main Memory and a portion of main memory where the system resides and executes. Any general-purpose computer, smartphone, or other mobile electronic device with an appropriate amount of storage space is suitable for this purpose. Computer and mobile electronic devices like these are well known in the art and are not pertinent to the invention. The system can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method for creating virtual focus group campaigns capable of execution by a computer, the method comprising the steps of:
a member signs up through a mobile website and downloads a mobile application to their mobile device;
the member creates and account and signs in to the system through the mobile application;
the member selects certain settings and provides personal information about which products or services they would be interested in evaluating or which goods or services they frequently use in their day to day lives;
a member is matched or selected to participate in a new survey such as a poll, advertisement, or coupon, they will receive a notification on their mobile device through the mobile application;
a member wishing to participate in the survey, will select or click on the notification and be taken to the queue, where they can see and select from one or more notifications that they have received.
the member clicks or selected an on screen button to be shown the next poll, ad, or coupon in their queue;
the member provides feedback to the survey; and
members are compensated for each response they provide and their earnings accumulate in their account until they decide to cash them out by way of a third party processor.

2. The method of claim 1, wherein
members provide feedback to polls by choosing yes or no or an answer from a multiple choice question, typically by selecting one of four possible answers.

3. The method of claim 1, wherein
members provide feedback to ads by choosing yes or no or an answer from a multiple choice question, typically by selecting one of four possible answers.

4. The method of claim 3, wherein
an image may also be shown as well as part of the question presented.

5. The method of claim 1, wherein
members provide feedback to coupons by choosing to either save the coupon to their coupon wallet or to discard the coupon because they have no interest in it.

6. The method of claim 1, wherein
members can earn significantly more money simply by referring others to sign up;
members gain access to more levels of compensation by referring more people that result in actual sign ups; and
members get paid extra anytime any of their personal referrals provides feedback, and also get paid extra whenever anyone that's within their referral network provides feedback.

7. The method of claim 1, further comprising the steps of:
an Advertiser, after setting up an account, would search the member database;
the Advertiser chooses the desired search area(s);
providing a total number of qualified members based on the search criteria;
choosing the number of desired responses;
choosing what type of campaign to create;
inserting the content for the campaign;
choosing the duration of the campaign;
choosing when campaign should be sent out; and
sending the campaign to all qualified members in the designated search area.

8. The method of claim 7, wherein
the cost of the campaign is directly related to the number of desired responses.

9. The method of claim 7, wherein
The types of campaigns include a poll, ad, or coupon.

10. The method of claim 9, wherein
polls consist of one question.

11. The method of claim 9, wherein
ads consist of some copy and an image.

12. The method of claim 9, wherein
coupons consist of the coupon details and an optional image.

13. The method of claim 7, wherein
once the campaign is deployed, members will submit their feedback through the mobile app., which the advertiser will receive.

14. The method of claim 13, wherein
feedback from members is provided in a couple different ways, depending on the type of campaign.

15. The method of claim 14, wherein
in polls and ads, feedback comes in the form of a choice of either yes or no answers or an answer from a multiple choice question.

16. The method of claim 14, wherein
with coupons, members provide their feedback by choosing to either save the coupon to their coupon wallet in the mobile app, or discard it if they are not interested in it.
